(19) United States
(12) Patent Application Publication
(10) Pub. No.: US 2003/0129916 A1
(43) Pub. Date: Jul. 10, 2003

(54) AC driven plasma display panel for electrical commercial boards and method of fabricating the same

(76) Inventor: Jun-Sei Lee, Seoul (KR)

Correspondence Address: BIRCH STEWART KOLASCH & BIRCH, PO BOX 747, FALLS CHURCH, VA, 22040-0747, US

(21) Appl. No.: 10/035,190

(22) Filed: Jan. 4, 2002

(51) Int. Cl. H01J 9/26

(52) U.S. Cl. 445/25

(57) ABSTRACT

This invention relates to an AC driven plasma display panel for electrical commercial boards and a method of fabricating the same wherein transparent electrodes and metal electrodes are formed outside of the display panel and a groove is cut on the opposite side of glass plate in parallel with each electrode to form a discharge cell by overlapping the groove in order to replace separation walls, transparent dielectric bodies and white dielectric bodies. The plasma display panel has a simple fabrication method with a lower driving voltage and has a lower fabrication cost by utilizing dielectric body layer as the upper and lower plates, cutting them to secure a discharge space and exposing the electrodes to outside without utilizing the dielectric body layer and separation wall. The plasma display panel can be used in building top commercial towers and public display boards such as an outdoor commercial tower, train time table display, bank terminal and Neon sign board.

### BACKGROUND OF THE INVENTION

This invention relates to an AC driven plasma display panel for electrical commercial boards, and more particularly to an AC driven plasma display panel for public display boards such as an electrical commercial board, train timetable display, bank terminal and Neon sign board and a method of fabricating the same.

FIG. 1 shows a cross sectional diagram of an AC driven plasma display panel (PDP display panel) consisting of an upper and lower plate which was conventionally used for a wall mountable TV or PC monitor. The upper plate protects a transparent display electrode 2 formed on a front face glass plate 1 through the vacuum deposition method, a glass based transparent dielectric body layer 3 which was baked in a thick layer through the screen printing method in order to control the current that flows during an AC driving and gas discharging. The upper plate comprises a protection layer 4 which was formed by vacuum-depositing an oxide material in order to lower the discharge voltage in terms of discharging surface electrons.

Also, an address electrode 6 is formed by the thick layer printing method using pasted silver. A discharge cell 11 which is capable of causing a gas discharge is secured by forming a separation wall 7 through the photo-etching, sand-blasting and screen printing methods after converting a white oxide material dielectric into a white dielectric layer 7 through the thick layer printing method on the rear face glass plate 5 of the lower plate. Fluorescent bodies 9A, 9B, 9C which can produce red, green and blue (RGB) colors are formed at the lower and side faces of the discharge cell 11 through the thick layer printing method.

The upper and lower plates are merged by baking in a thick layer using a sealant. A Plasma Display Panel (PDP) is fabricated by evacuating the air in the discharge cell 11 and injecting a mixture of Xenon (Xe), Neon (Ne) and Helium (He) gases into the discharge cell 11. When an AC is applied between the electrodes 2, 6 of the plasma display panel, ultraviolet light is produced due to the discharging of the Xenon gas in the discharge cell 11. The fluorescent bodies 9A, 9B, 9C are excited by the discharged ultraviolet and consequently generate red, green and blue of the visible light 12A, 12B, 12C through the front face glass plate 1.

In order to reproduce the fine pictures in plasma display panels for the conventional wall mountable TV, the width and height of the discharge cell 11 should be fabricated within the order of several hundreds micron meters.

Hence, the separation wall which has the width and height in the range of 10 μm and 100 μm respectively should be formed with precision through the photo-etching, sand-blasting and screen printing methods. The fabrication cost increase is mainly due to the low yield during the separation wall formation process. Another factor in the fabrication cost increase is due to the baking in a thick layer of the expensive transparent dielectric body 3 and white dielectric body 7 in the range of several hundreds micron meters.

Moreover, the electrodes 2, 6 are formed inside of the front and rear faces of the glass plate 15 in order to face the discharge cell 11 and since the electrodes are protruding from the sealant 10 as shown in FIG. 1, the application of the electrodes in large size display panels by merging plurality of panels such as an outdoor commercial display for the purpose of displaying a large picture above 100 inches is very limited.

### SUMMARY OF THE INVENTION

The conventional plasma display panel (PDP) for public display boards such as an electrical commercial board, train time table display, bank terminal and Neon sign board do not require finely defined pixels that are necessary for PDP display panels such as a wall mountable TV. As a result, the size of a discharge cell could be maintained within a size of few mm.

Hence, if the space interval and width between each separation wall are maintained within a size of few mm, then the characters and pictures can be displayed without losing readability from a long distance. Therefore, the precise separation wall fabrication technology used for PDP display panels of a wall mountable TV in order to obtain a fine discharge cell is not required.

However, due to the increase in the size of a discharge cell to a size of few mm, the height of a discharge cell also has increased proportionately. As a result, in order to generate a gas discharge, a high voltage around 1 kV should be applied between the two electrodes. In the PDP display panel which has a multi-layer structure comprising a front face glass plate/display electrode (transparent electrode)/transparent dielectric body/discharge cell/fluorescent body/white dielectric/address electrode/rear face glass plate, the voltage being applied to the discharge cell becomes large when the thickness of a dielectric body layer is thick and the height of a discharge cell is higher than the thickness of the dielectric body layer.

Recently, a multi-layer structure comprising display electrode (transparent electrode)/front face glass plate/discharge cell/fluorescent body/white dielectric/address electrode/rear face glass plate is fabricated by altering the front glass plate of a PDP display panel in order to apply it to the PDP electronic commercial board. In this case, however, the driving voltage is very high since the front glass plate is thick (a few mm thickness) and the discharge cell is small as previously mentioned.

The present invention is designed to overcome the above problems of prior art. The object of the invention is to provide an AC driven plasma display panel for public display boards and a method of fabricating the same wherein the plasma display panel has a simple fabrication method with a lower driving voltage and has a lower fabrication cost by utilizing dielectric body layers as the upper and lower plates, cutting them to secure a discharge space and exposing the electrodes to outside without utilizing the dielectric body layer and separation wall.

### BRIEF DESCRIPTION OF THE DRAWINGS

FIG. 1 shows a cross sectional diagram of an AC driven plasma display panel which was conventionally used for a wall mountable TV or PC monitor.

FIG. 2 is an exploded view of an AC driven plasma display panel for public display boards according to the present invention.

FIG. 3 is a cross sectional view of an AC driven plasma display panel for public display boards according to the present invention.

### DESCRIPTION OF THE NUMERIC ON THE MAIN PARTS OF THE DRAWINGS

1: Front Face Glass Plate

2: Display Electrode (Transparent Electrode)

3: Transparent Dielectric Body Layer

4: Protective Layer

5: Rear Face Glass Plate

6: Address (Metal) Electrode

7: White Dielectric Body Layer

8: Separation Wall

9A: Red Fluorescent Body

9B: Green Fluorescent Body

9C: Blue Fluorescent Body

10: Sealant

11: Discharge Cell

12A: Red Light

12B: Green Light

12C: Blue Light

13: Glass Separation Wall

### DETAILED DESCRIPTION OF THE EMBODIMENTS

In order to achieve the above objects of the present invention, the present invention replaces separation walls, transparent electrodes and white dielectric bodies by forming the transparent electrodes and metal electrodes outside of the plasma panel and forming a discharge cell by merging a groove which were constructed by cutting the opposite side of the glass in parallel with each electrode.

Hereinafter, preferred embodiments of the present invention will be described in detail with reference to the accompanying drawings.

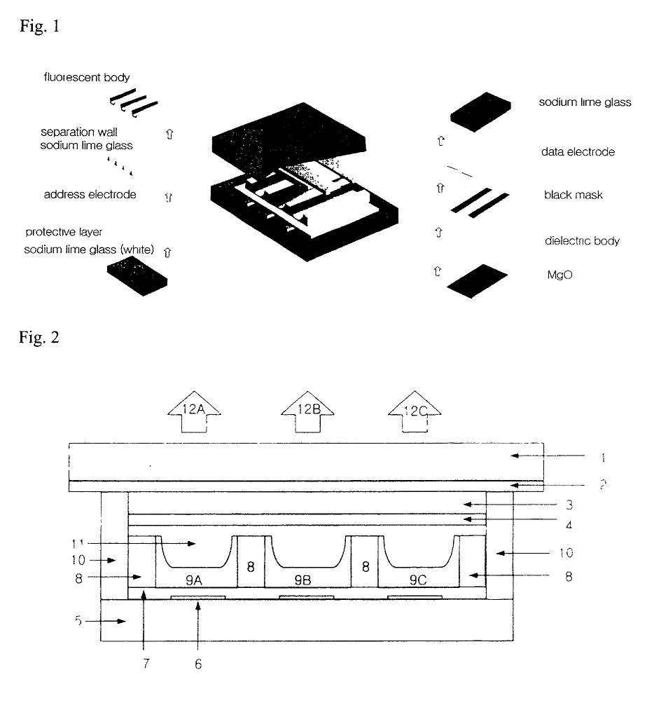

FIG. 2 is an exploded view of an AC driven plasma display panel for public display boards according to the present invention.

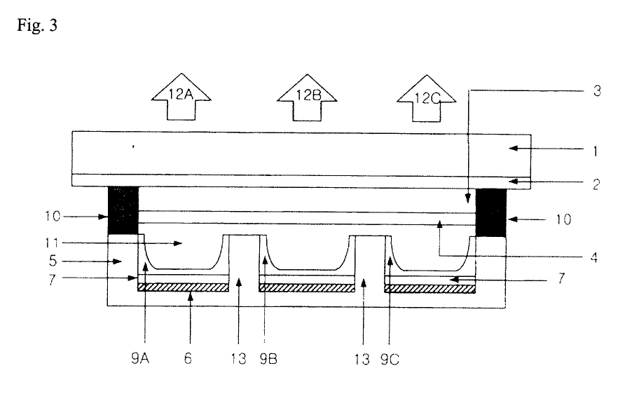

FIG. 3 is a cross sectional view of an AC driven plasma display panel for public display boards according to the present invention.

FIG. 2 shows an transformed structure of the conventional wall mountable TV into a PDP display board which can be driven at a low voltage and has a low fabrication cost comprising a front face glass plate/transparent electrode/transparent dielectric body/protective layer/discharge cell/white dielectric body/metal electrode/rear face glass plate (the front face glass plate 1 as shown in FIG. 1 is rotated to 90 degree in the real structure).

According to the present invention, a transparent electrode 2 and protective layer 4 are formed on the upper and lower face of the front face glass plate 1 which was cut. Likewise, below the rear face glass plate 5, a metal electrode 6 is formed and red, green and blue fluorescent bodies 9A, 9B, 9C are merged through a sealant 10 on the above. Also, the common structural characteristics show that the transparent dielectric body 3 and white dielectric body 7 are omitted

Below shows the detailed fabrication method of a PDP display panel. First of all, after depositing around several thousands Å thickness of Indium Tin Oxide (In2O3Sn) on a front face glass plate with a thickness of 3 mm, a transparent electrode 2 with the width of a length of few mm is formed through the photo-etching or sand-blasting method. Also, the transparent electrode 2 can be directly formed by the vacuum depositing method which involves covering the front face glass plate with a metal mask with the width of a few mm. A glass separation wall with the width of 4 mm and height of 2 mm is formed by cutting a groove with the depth of 2 mm and width of 4 mm on the opposite side of the transparent electrode 2 by sand-blasting the front face glass plate where the transparent electrode 2 is formed. A protective layer 3 is formed by depositing several thousand Å thickness through the vacuum deposition method which involves covering Magnesium Oxide (MgO) between the separation wall 13 with the metal mask.

Also, a metal electrode 6 with a width of a length of few mm is formed through the photo-etching or sand-blasting method after depositing several thousand Å thickness of Chrome (Cr) or Aluminum (Al) which has a good light reflection ratio on the glass plate and is the same material as the front face glass plate. Also, the metal electrode 6 can be directly formed by the vacuum depositing method which involves covering the rear face glass plate with a metal mask with a width of a few mm.

The rear face glass plate where the metal electrode 6 is formed by sand-blasting is placed in parallel with metal electrode 6 which is formed depth of 2 mm on the opposite side. Red, green and blue fluorescent bodies 9A, 9B, 9C are plastic after printed between glass separation wall 13 by the thick layer printing method or the spout method. After the thick layer printing the sealant 10 which has fleet glass as the main composition, the fabricated front face glass plate 1 and rear face glass plate 5 fused together in a electrical furnace while the transparent electrode 2 and metal electrode is overlapping at a right angle. After evacuating the air in the discharge cell 11 of the merged display panel, and injecting a mixture of Xenon (Xe), Neon (Ne) and Helium (He) gases into the discharge cell 11. When an AC voltage of 300V with a frequency 30 KHz is applied between the transparent electrodes 2 and metal electrode 6 of the plasma display panel, ultraviolet light is produced from the discharging of the gas mixture in the discharge cell 11. The fluorescent bodies 9A, 9B, 9C are excited by the discharged ultraviolet and consequently generate red, green and blue of the visible light 12A, 12B, 12C. By selectively operating the necessary pixel region for displaying characters or pictures, the characters or pictures can be displayed.

Also, the front and rear face glass plates 1, 5 maintain a single body intersecting structure which prevents the bending of the glass plate by the atmospheric pressure. Moreover the transparent electrodes 2 and metal electrode 6 are formed at outside of the glass plate so as to allow an easy connection between driving circuits and electrodes as well as preventing the protrusion of the connections between the electrodes.

The present invention not only replaces the separation wall 8 of the conventional PDP display panel through cutting the glass but also replaces separation walls, transparent electrodes and white dielectric bodies resulting a decrease in the number of fabrication steps and fabrication cost. Also by comparatively enlarging the discharge cell 11 through a thickness reduction of the glass plate, it can operate at a lower driving voltage. The front and rear face glass plates 1, 5 of the PDP display panel fabricated according to the present invention maintain a single body intersection structure which prevents bending of the glass plate by the atmospheric pressure. Moreover the transparent electrodes 2 and metal electrode 6 are formed at outside of the glass plate so as to allow an easy connection between driving circuits and electrodes as well as preventing protrusion of the connections between the electrodes. The PDP display panel fabricated according to the present invention does not use separation walls and dielectrics resulting a decrease in the fabrication cost as well as halving the driving voltage value.

What is claimed is:

1. An AC driven plasma display panel for electrical commercial boards fabrication method wherein transparent electrodes and metal electrodes are formed outside of the display panel and a groove is cut on the opposite side of glass plate in parallel with each electrode to form a discharge cell by overlapping the groove in order to replace separation walls, transparent dielectric bodies and white dielectric bodies.

2. The method as claimed in claim 1 wherein said front and rear face glass plates maintain a single body intersecting structure which prevents the bending of the glass plate by the atmospheric pressure.

3. The method as claimed in claim 1 or claim 2 wherein by cutting said glass plate to make said discharge cell comparatively larger through reduction of the thickness of the glass plate in order to be able to operate at a lower driving voltage.

4. The method as claimed in claim 1 or claim 2 wherein by forming said transparent electrodes and metal electrodes outside of the glass plate in order to avoid the protrusion of said electrodes outside the sealant.

5. An AC driven plasma display panel fabricated according to claim 1 wherein said AC driven plasma display panel is used for building top commercial towers and public display boards such as an outdoor commercial tower, train time table display, bank terminal and Neon sign board.
